(19) United States
(12) Patent Application Publication
(10) Pub. No.: US 2025/0337906 A1
(43) Pub. Date: Oct. 30, 2025

(54) END OF BLOCK CONTEXT USING PREDICTION TEXTURE

(71) Applicant: GOOGLE LLC, Mountain View, CA (US)

(72) Inventors: Lin Zheng, Waterloo (CA); Yaowu Xu, Saratoga, CA (US); Jingning Han, Santa Clara, CA (US)

(21) Appl. No.: 19/192,565

(22) Filed: Apr. 29, 2025

Related U.S. Application Data
(60) Provisional application No. 63/639,857, filed on Apr. 29, 2024.

(51) Int. Cl. H04N 19/13; H04N 19/167; H04N 19/176; H04N 19/61

(52) U.S. Cl. CPC H04N 19/13; H04N 19/167; H04N 19/176; H04N 19/61

(57) ABSTRACT

The present disclosure provides a method, apparatuses and non-transitory computer readable medium for encoding or decoding an end-of-block position of a transform block. The method includes determining a context for the end-of-block position based on an indication of texture of prediction pixels for a current block corresponding to a transform block, and entropy coding or entropy decoding the end-of-block position based on the context. The indication of texture may be determined by calculating a variance of the prediction pixels or by calculating a discrete cosine transform of the prediction pixels. A non-transitory computer-readable medium includes instructions for performing the method. A non-transitory computer-readable medium storing a compressed bitstream including an encoded end-of-block position is also provided, wherein the encoded end-of-block position is encoded by an encoder or decodable by a decoder based on the context determined from the indication of texture of prediction pixels.

### CROSS-REFERENCE TO RELATED APPLICATION(S)

This disclosure claims the benefit of U.S. Provisional Patent Application No. 63/639,857 filed Apr. 29, 2024, the disclosure of which is incorporated by reference herein in its entirety.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using end of block context using prediction texture.

An aspect is a method for encoding or decoding an end-of-block position of a transform block. The method includes determining a context for the end-of-block position based on an indication of texture of prediction pixels for a current block corresponding to a transform block, and entropy coding or entropy decoding the end-of-block position based on the context.

An aspect is a non-transitory computer-readable medium storing instructions, that when executed by a computer, cause the computer to encode or decode an end-of-block position of a transform block by determining a context for the end-of-block position based on an indication of texture of prediction pixels for a current block corresponding to a transform block, and entropy coding or entropy decoding the end-of-block position based on the context.

An aspect is a non-transitory computer-readable medium storing a compressed bitstream including an encoded end-of-block position, wherein the encoded end-of-block position is encoded by an encoder or decodable by a decoder based on a context that is determined based on an indication of texture of prediction pixels for a current block corresponding to a transform block.

Variations in these and other aspects will be described in additional detail hereafter.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this

### DISCLOSURE

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is an illustration of decoding a block using a prediction and a residual in accordance with implementations of this disclosure.

FIG. 8 is a flow diagram of an example technique for decoding an encoded video bitstream.

FIG. 9 is a flow diagram of an example technique for encoding a video stream.

FIG. 10 is a flow diagram of an example technique for encoding or decoding an end-of-block position of a transform block.

FIG. 11 is an example table of models corresponding to transform block sizes.

### DETAILED DESCRIPTION

Compression schemes related to coding video streams may include breaking images into blocks and generating a digital video output bitstream using one or more techniques to limit the number of bits included in the output. A received bitstream can be decoded to re-create the blocks and the source images from the limited information. Encoding a video stream, or a portion thereof, such as a frame or a block, can include using temporal or spatial similarities in the video stream to improve coding efficiency. For example, a current block of a video stream may be encoded based on identifying a difference (residual) between certain pixel values in a previously coded frame and those in the current block. In this way, only the residual and parameters used to generate it need be added to the bitstream instead of including the entirety of the current block. This technique may be referred to as inter-prediction. Other prediction techniques may also be utilized (such as intra prediction).

The residual may be encoded using a multi-step process which may include transforming the residual values into the frequency domain (such as by using a discrete cosine transform (DCT)), represented by transform coefficients, quantizing the transform coefficients (this introduces the lossyness in compression), and then entropy coding the quantized transform coefficients.

Entropy is generally considered the degree of disorder or randomness in a system. Entropy coding compresses a sequence in an informationally efficient way (and entropy decoding reverses that compression to obtain the original sequence). That is, a lower bound of the length of the compressed sequence is the entropy of the original sequence. An efficient algorithm for entropy coding desirably generates a code (e.g., in bits) whose length approaches the entropy. For a particular sequence of syntax elements, the entropy associated with the code may be defined as a function of the probability distribution of observations (e.g., symbols, values, outcomes, hypotheses, etc.) for the syntax elements over the sequence. Arithmetic coding can use the probability distribution to construct the code.

Probability estimation may be used in video codecs to implement entropy coding. That is, the probability distribution of the observations may be estimated using one or more probability estimation models (also called probability models herein) that model the distribution occurring in an encoded bitstream so that the estimated probability distribution approaches the actual probability distribution. According to such techniques, entropy coding can reduce the number of bits required to represent the input data to close to a theoretical minimum (i.e., the lower bound).

A probability estimation model for a given symbol may be selected based on the context of the symbol being decoded. For example, the context of the symbol may include the values of previously decoded symbols (or information derived from one or more of those previously decoded symbols) that may provide insight into what the value of the current symbol may be. By using different probability estimation models for a given symbol depending on context, the given symbol may be more efficiently encoded because there may be less entropy for a given context and/or a probability estimation model may be able to model the probability distribution more accurately for a given context.

An item that impacts the compression efficiency of a video bitstream is the end-of-block position for a transform block. The end-of-block position indicates the location of the last non-zero quantized transform coefficient in a transform block so that the remaining zero quantized transform coefficients do not need to be individually encoded. Instead, the decoder can assign zero values to the remaining quantized transform coefficients based on the end-of-block position. This may result in a more efficient encoding because in many quantized transform blocks, there are many zero valued quantized transform coefficients towards the end of the block (such as based on a scan order starting from the top left transform coefficient to the bottom right transform coefficient). This is because the coefficients towards the end of the block represent higher frequency information which may be less likely to be present or may be present at lower amounts which may be quantized out to zero. Depending on the implementation, the end-of-block position may be defined as the position, in the scan order, of the last non-zero coefficient, the position immediately following the position of the last non-zero coefficient, or another indicator that identifies the position of the last non-zero quantized transform coefficient.

A previously decoded symbol(s) that may provide useful context for the end-of-block symbol is the transform block size for the current transform block. The possible range of end-of-block position values may change depending on block size (e.g., in a 4×4 block there are 16 quantized transform coefficients and in a 8×8 block there are 64 quantized transform coefficients). Other previously decoded symbols that may provide useful context include an intra/inter mode and color plane. For example, different models may be used depending on whether the transform block is in a chroma color plane, is in a luma color plane and encoded using inter prediction and is in a luma color plane and encoded using intra prediction. These contexts may help to reduce the entropy (and therefore the compression available through entropy coding) as compared to the absence of any context. However, the end-of-block position may still vary widely, even when limited to a particular context of a transform block having a certain number of transform coefficients, a prediction methodology, a color plane, or a combination thereof. Accordingly, an improved context is needed to reduce the entropy associated with a given context for the end-of-block position and to permit more accurate modeling of the probability distribution.

Implementations of this disclosure solve problems such as these by utilizing an indication of the texture of prediction pixels used to reconstruct a decoded block corresponding to the transform block as context when entropy coding and decoding the end-of-block position for the transform block. For clarity, the prediction pixels are those identified or created in the decoding process to predict the values of the decoded block of pixels corresponding to the transform block. Depending on the implementation, the prediction pixels may be determined in a prediction process that generates prediction pixels using prediction blocks of a different size than the transform blocks. The prediction pixels used to determine context for a given transform block are those prediction pixels that correspond spatially to the given transform block. The use of the texture of prediction pixels as context may reduce entropy and result in a more compact representation because the variation of pixels in the prediction may correspond in some manner to the variation of values in the residual.

The indication of texture of the prediction pixels can be determined using one or more of a variety of different techniques. For example, a variance of the prediction pixels may be computed, such as a sum of absolute differences (SAD), a sum of squared differences (SSD) or other computation designed to provide a value indicating the variance, texture, or other change or rate of change of values between the prediction pixels. For example, such other computation could include computing a DCT or other transform on the prediction pixels to produce transform coefficients representing the prediction pixels as a group.

The indication of texture may be utilized along with one or more thresholds to select one or more different probability estimation models to entropy code or decode the end-of-block position. For example, a first model may be used if the calculated variance is less than a threshold and a second model may be used if the calculated variance is greater than the threshold. The threshold may be changed depending on other context. For example, a first threshold may be used if the transform block is in a chroma plane or corresponds to intra predicted prediction pixels and a second threshold may be used if the transform block is in a luma plane and corresponds to inter predicted prediction pixels. For example, in the event that a DCT or other transform is computed, a first model may be used if only the first transform coefficient (the DC coefficient) is non-zero and otherwise a second model may be used. Alternatively, the computed transform coefficients corresponding to the prediction pixels may be quantized and the model may be selected based on the quantized transform coefficients.

Implementations of end of block context using prediction texture are now further described.

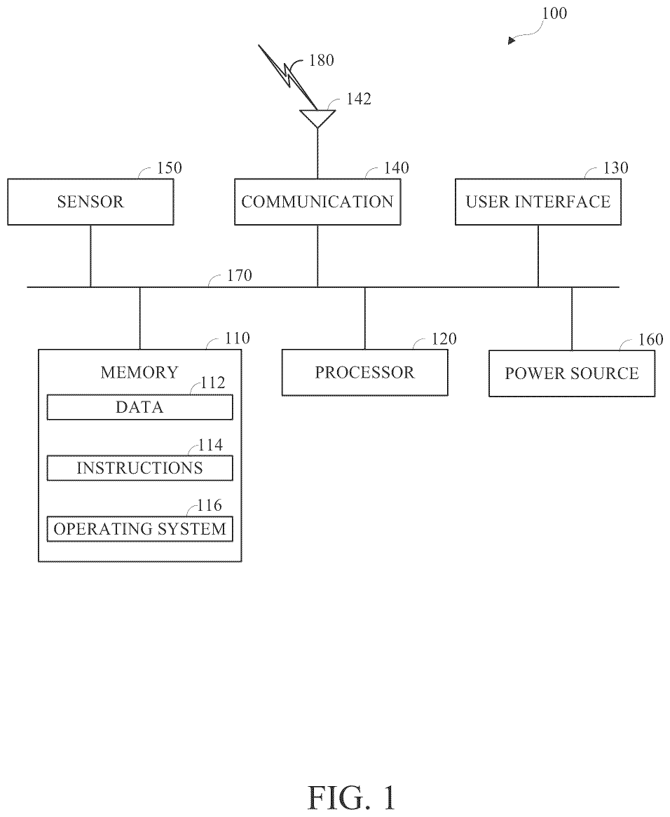

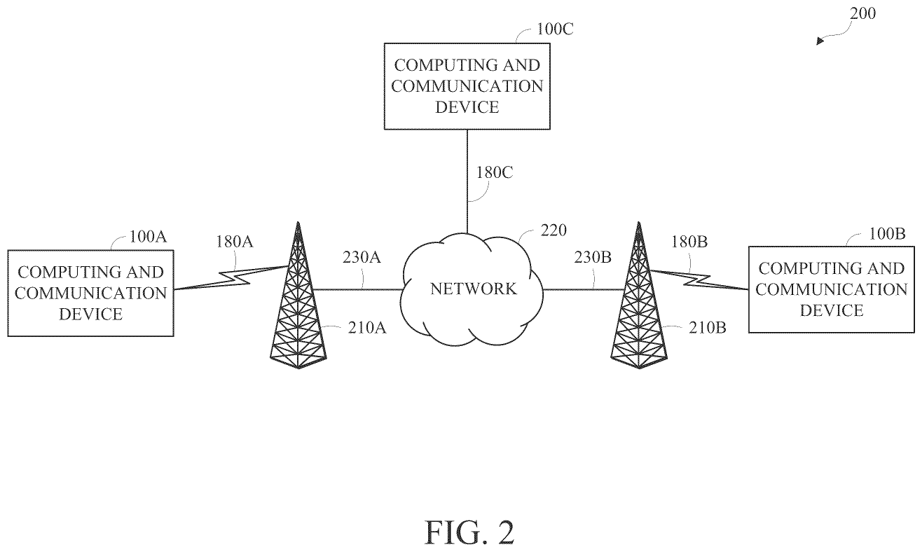

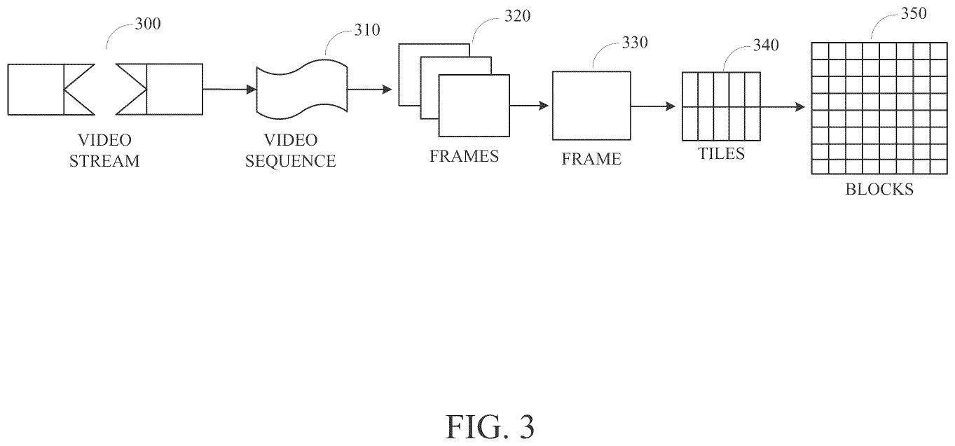

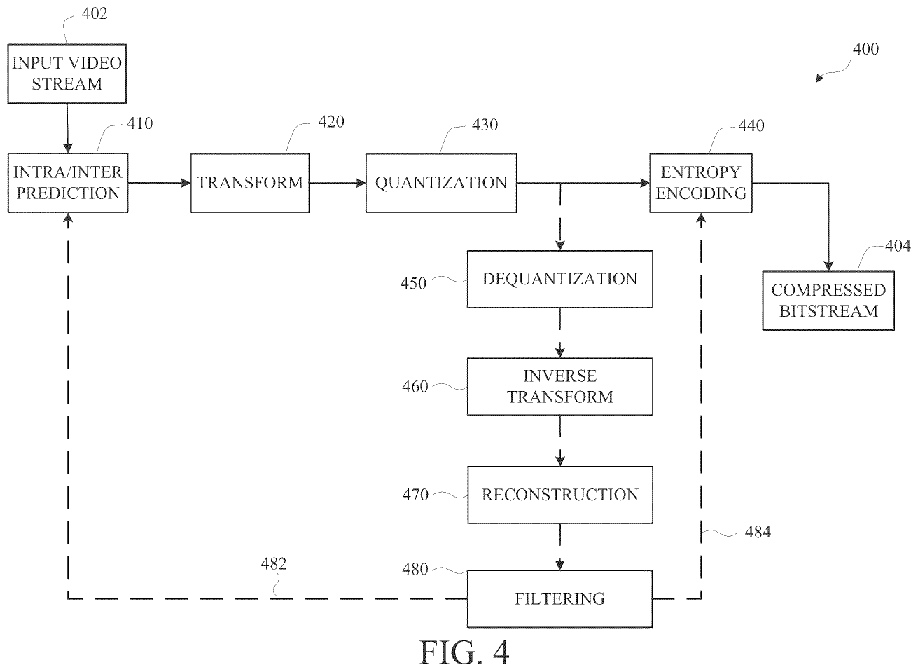

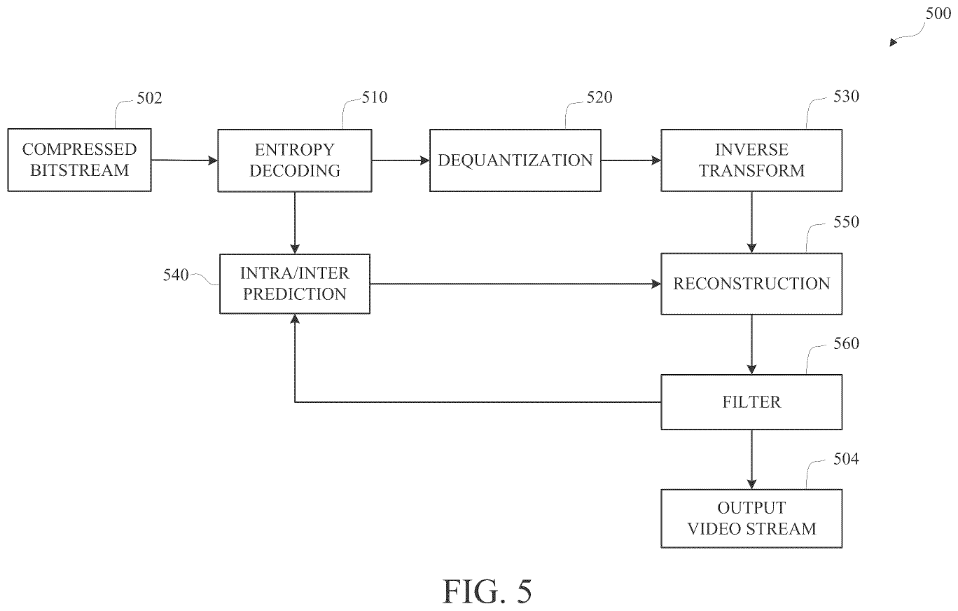

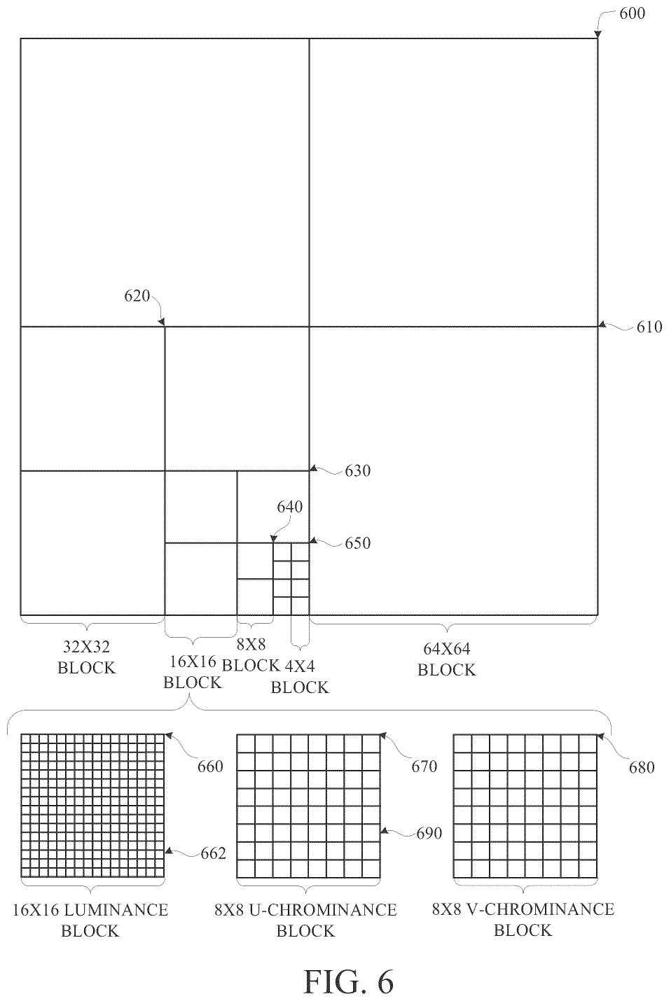

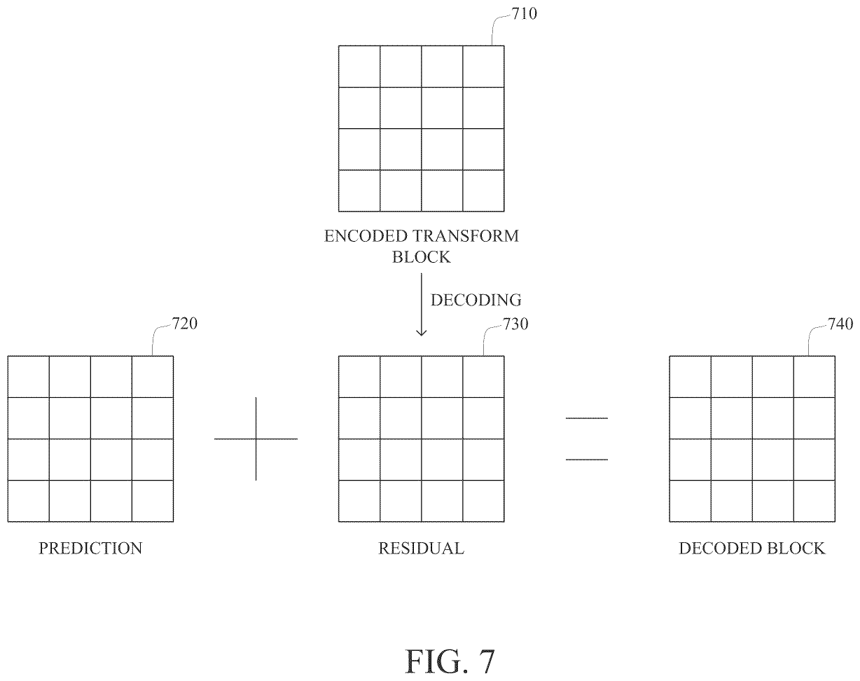

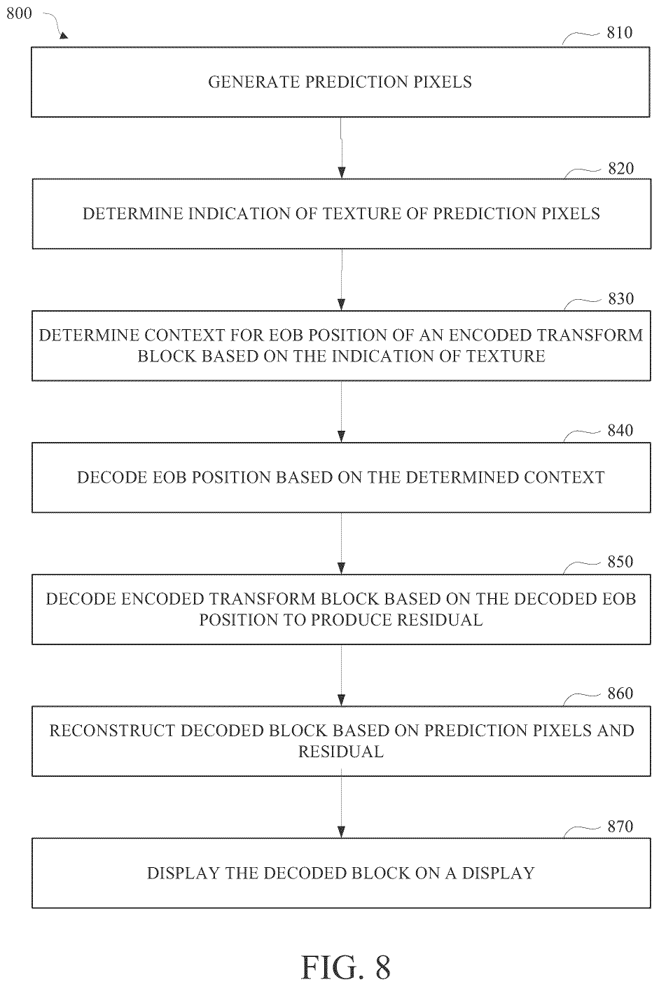

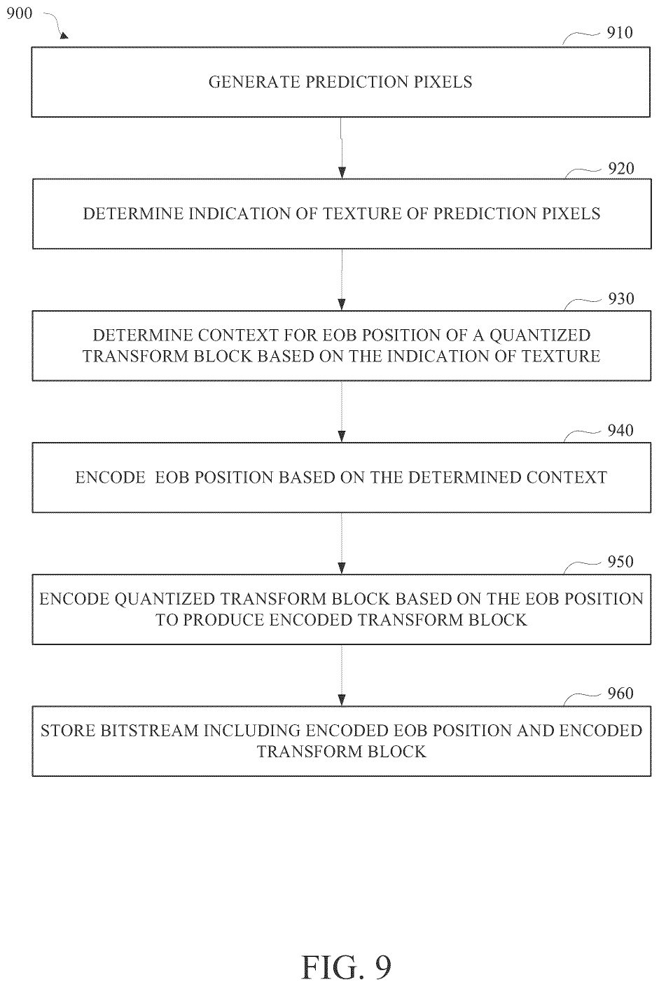

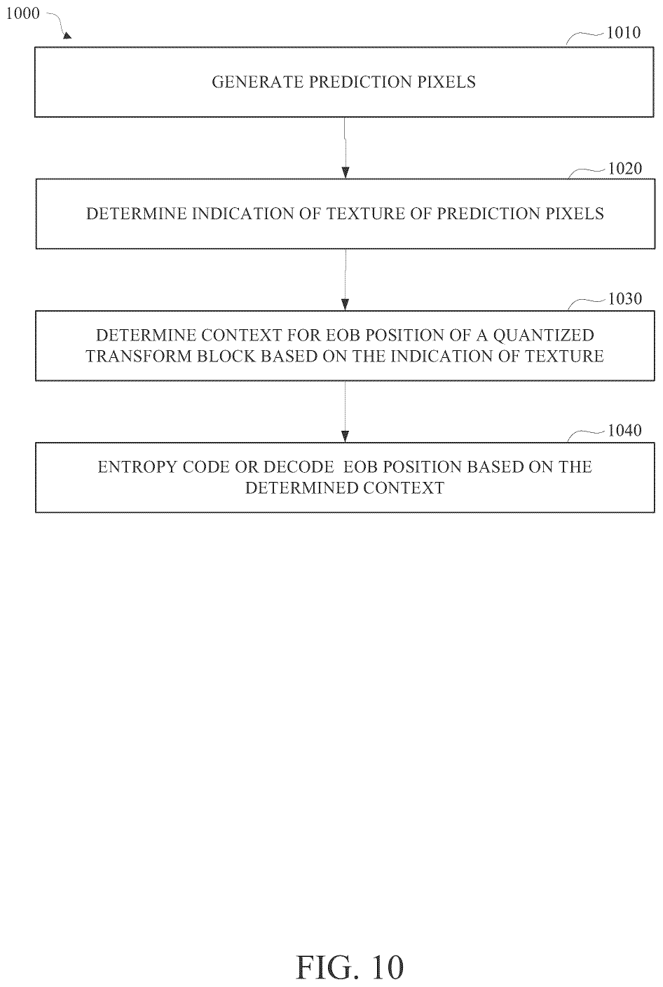

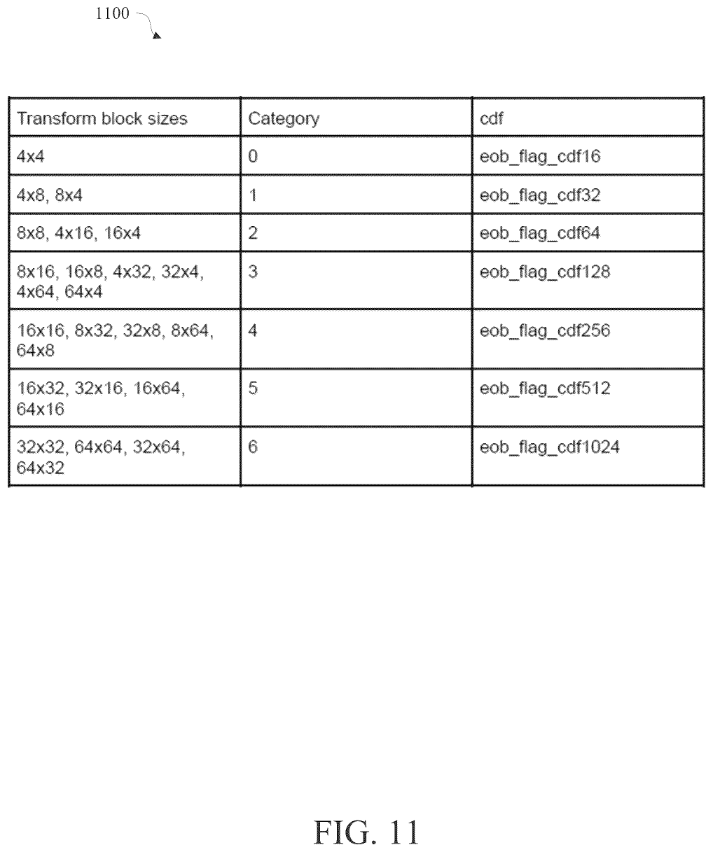

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input video data, encoded video data, decoded video data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof video data and one or both of the computing and communication device 100A and the computing and communication device 100B may receive, decode, process, store, present, or a combination thereof the video data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communication devices, networks, and access points.

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

A frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. A tile 340 may be a rectangular region of the frame that can be coded independently. Tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

Some implementations may include additional or fewer components than described with respect to FIG. 3. For example, some implementations may not utilize tiles. For example, some implementations may utilize slices or some other intermediate partitioning of a frame instead of tiles. For example, some implementations may utilize different block structures. For example, some implementations may utilize variable block sizes. For example, some implementations may utilize a hierarchical block structure with two or more levels of blocks with different sizes (e.g., in a quad-tree type structure) where different information is coded at different block levels.

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame. The motion vector may be generated at a sub-pixel precision. In such a case, interpolation may be utilized to approximate the pixels of the prediction block based on decoded pixels in the reference frame.

The intra/inter prediction unit 410 may subtract the prediction block from the current block (raw block) to produce a residual block. The transform unit 420 may perform a block-based transform, which may include transforming a block of residual pixels into a transform block of transform coefficients in, for example, the frequency domain. The block of pixels used to create a transform block may be the same or different than the blocks used to generate the prediction and residual blocks. For example, a transform block may be a subdivision of a residual block or residual values in a frame may be partitioned using a different block partitioning scheme altogether as compared to the blocks used to produce the residual values. Examples of block-based transforms include the Karhunen-Loève Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix. In some implementations,

The quantization unit 430 may convert the transform coefficients into discrete quantized values, which may be referred to as quantized transform coefficients or quantization levels. The quantized transform coefficients can be entropy encoded by the entropy encoding unit 440 to produce entropy-encoded coefficients. Entropy encoding can include using a probability distribution metric, Context Adaptive Binary Arithmetic Coding, or a combination thereof. Other techniques for entropy encoding, such as those described elsewhere in this disclosure, may be utilized. The entropy-encoded coefficients and information used to decode the transform block, which may include the type of prediction used, motion vectors, and quantizer values, can be output to the compressed bitstream 404. The compressed bitstream 404 can be formatted using various techniques, such as run-length encoding (RLE) and zero-run coding.

The reconstruction path can be used to maintain prediction synchronization between the encoder 400 and a corresponding decoder, such as the decoder 500 shown in FIG. 5. The reconstruction path may be similar to the decoding process discussed below and may produce an output equivalent to that produced by the decoding process to enable prediction at both the encoder and the decoder to produce the same results. The reconstruction process may include decoding the encoded frame, or a portion thereof, which may include decoding an encoded transform block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. In the event that different block sizes or partitioning schemes are used for prediction and transform, decoded residual values from multiple transform blocks may be utilized when reconstructing a decoded block of pixels using a prediction block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of a current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, in some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. Other techniques for entropy decoding, such as those described elsewhere in this disclosure, may be utilized. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502.

A video coding standard may specify the requirements to produce a compliant decoder. Such a standard may not specify how to make a video encoder or may provide only certain requirements as to what must be included in a compliant encoder. Instead, an encoder is compliant if it produced a video bitstream that is capable of being decoded by a compliant video decoder. Accordingly, certain tools are implemented to produce the same results in both the encoder and decoder, such as contexts for entropy coding and decoding an end-of-block position of a transform block.

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16-pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order. In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x, y}. Similarly, a pixel of the search area of the reference frame may be indicated based on location using Cartesian coordinates as r_{x, y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform blocks, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding, such as video coding using transform partitioning, may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

FIG. 7 is an illustration of decoding a block using a prediction and a residual in accordance with implementations of this disclosure. Illustrated in FIG. 7 is encoded transform block 710, prediction 720, residual 730, and decoded block 740. As illustrated, encoded transform block 710 is decoded to produce residual 730. The values of prediction 720 and the values of residual 730 are added together to produce decoded block 740. For example, the top left value of prediction 720 is added to the top left value of residual 730 to produce the top left value of decoded block 740. Variations of the foregoing process are possible that utilize prediction 720 and residual 730 to produce decoded block 740 (e.g., instead of or in addition to an addition of values).

The illustration of FIG. 7 may correspond to decoding as described in FIG. 5, for example, with respect to the compressed bitstream 502 (e.g., in which encoded transform block 710 is obtained from), entropy decoding unit 510, dequantization unit 520, and inverse transform unit 530 (e.g., from which residual 730 is obtained from), inter/intra prediction unit 540 (e.g., from which prediction pixels included in prediction 720 is obtained from), and reconstruction unit 550 (e.g., from which decoded block 740 is obtained from.

With respect to the use of prediction pixels in prediction 720 as context for decoding the encoded transform block 710, certain steps of decoding with respect to prediction (e.g., with respect to intra/inter prediction unit 540) may need to be performed before certain steps of entropy decoding (e.g., with respect to entropy decoding unit 510). For example, as described later with respect to entropy encoding and decoding of the end-of-block position, in order to obtain the necessary context, the prediction pixels corresponding to the transform block are utilized, and as such, in implementations of this disclosure, the intra/inter prediction process relating to such transform block may be completed before entropy decoding of the encoded transform coefficients.

Portions of the illustration of FIG. 7 may correspond to encoding as described in FIG. 6. For example, encoded transform block 710 may be included in compressed bitstream 404 which is produced by entropy encoding unit 440. For example, the reverse of all or portions of the process described above with respect to decoding may be performed by the encoder in order to generate the encoded transform block 710.

FIG. 7 depicts each of encoded transform block 710, prediction 720, residual 730, and decoded block 740 as a 4×4 matrix of values for illustrative purposes, however in implementations, the block sizes used may be different (such as described previously). In addition, the block size used to generate the prediction pixel values associated with prediction 720 may be different than the block size used for the encoded transform block which may be different than the block size used to combine the prediction and residual to produce a decoded block.

The encoded transform block may be encoded and decoded using arithmetic coding, such as in entropy encoding unit 440 and entropy decoding unit 510. For example, symbols representing an end-of-block position and various quantized transform coefficients in the transform block may be entropy coded using arithmetic coding to losslessly reduce the number of bits used to represent the symbols to a number of bits approaching the entropy of the data represented by the symbol. Different contexts may be used for different types of symbols in order to select a probability estimation model to utilize for the arithmetic coding for a particular symbol. The probability estimation model can indicate the statistical probability of the likelihood of occurrence of different symbol values in order to optimize the number of bits (or fractional bits) allocated to the arithmetically coded representation of those symbol values.

As previously described, the end-of-block position may be defined in some implementations as the last non-zero coefficient index. With respect to an end-of-block position, context including transform block size, inter/intra mode, and color plane may be utilized to select a probability estimation model. The following process describes an example of how an end-of-block position token (eob_pt) may be decoded and used to generate an end-of-block position used to decode a transform block.

First, an eob position token (eob_pt) may be decoded. In some implementations, eob_pt is entropy coded with a probability estimation model, chosen from seven possible models (represented as cumulative distribution functions (CDF)) according to the number of samples of the transform block, as set forth in the table 1100 depicted in FIG. 11. The probability estimation model (represented as a CDF) may be selected from the following arrays of models based on the CDF array identified according to transform block size identified in FIG. 11:

CDF array definitions:
eob_flag_cdf16[EOB_PLANE_CTXS][CDF_SIZE(EOB_MAX_SYMS − 6)];
eob_flag_cdf32[EOB_PLANE_CTXS][CDF_SIZE(EOB_MAX_SYMS − 5)];
eob_flag_cdf64[EOB_PLANE_CTXS][CDF_SIZE(EOB_MAX_SYMS − 4)];
eob_flag_cdf128[EOB_PLANE_CTXS][CDF_SIZE(EOB_MAX_SYMS − 3)];
eob_flag_cdf256[EOB_PLANE_CTXS][CDF_SIZE(EOB_MAX_SYMS − 2)];
eob_flag_cdf512[EOB_PLANE_CTXS][CDF_SIZE(EOB_MAX_SYMS − 1)];
eob_flag_cdf1024[EOB_PLANE_CTXS][CDF_SIZE(EOB_MAX_SYMS)];
where EOB_PLANE_CTXS = 3, EOB_MAX_SYMS = 11, and
CDF_SIZE(EOB_MAX_SYMS) is the maximum number of symbols used to represent
eob_pt (which may be reduced based on the transform block size).

The value used for the first index of the context for a particular transform block (identified as eob_plane_context below and EOB_PLANE_CTXS above) may be calculated as described in the following pseudocode. The variables plane and mode refer to an indication of whether the color plane is chroma and whether inter or intra coding is utilized.

```
if (plane == Chroma_plane) {
  eob_plane_context = 2;
} else if (mode == intra) {
  eob_plane_context = 0;
} else if (mode == inter) {
  eob_plane_context = 1;
}
```

The symbol is then decoded from the corresponding cdf from the arrays described above. One is added to the symbol to obtain eob_pt.

Next, the end-of-block position may be determined by adding eob_pt to the value of another syntax element (eob_extra_value), such as shown using the following pseudocode:

if (eob_pt <= 2) {
EOB = eob_pt;
} else {
EOB = av1_eob_group_start[eob_pt] + eob_extra_value.
}

In the foregoing pseudo code,
av1_eob_group_start[12]={0, 1, 2, 3, 5, 9, 17, 33, 65, 129, 257, 513}, and
eob_extra_value can be considered as the remainder, which is coded separately.

The foregoing process may be improved by also utilizing an indication of the texture (e.g., which may include a calculated variance, such as a SAD or SSD) of prediction pixels corresponding to the transform block as context. For example, a larger variance may correlate with a higher chance to have more high frequency coefficients, which may lead to a larger end-of-block position. In an example implementation of such an improvement, the CDF array definitions may be updated to include another array dimension as follows:

eob_flag_cdf16[EOB_PLANE_CTXS][NUM_PRED_VAR][CDF_SIZE(EOB_MAX_SYMS − 6)];
eob_flag_cdf32[EOB_PLANE_CTXS][NUM_PRED_VAR][CDF_SIZE(EOB_MAX_SYMS − 5)];
eob_flag_cdf64[EOB_PLANE_CTXS][NUM_PRED_VAR][CDF_SIZE(EOB_MAX_SYMS − 4)];
eob_flag_cdf128[EOB_PLANE_CTXS][NUM_PRED_VAR][CDF_SIZE(EOB_MAX_SYMS − 3)];
cob_flag_cdf256[EOB_PLANE_CTXS][NUM_PRED_VAR][CDF_SIZE(EOB_MAX_SYMS − 2)];
eob_flag_cdf512[EOB_PLANE_CTXS][NUM_PRED_VAR][CDF_SIZE(EOB_MAX_SYMS − 1)];
eob_flag_cdf1024[EOB_PLANE_CTXS][NUM_PRED_VAR][CDF_SIZE(EOB_MAX_SYMS)];

In the foregoing CDF definitions, NUM_PRED_VAR represents the number of CDFs allocated based on the indication of texture. For example, NUM_PRED_VAR can be equal to two when the indication of texture is applied to a single threshold to result in a first CDF being used for higher variances and a second CDF being used for lower variances.

In some implementations, a variable (pred_var_ctx) can be derived from the variance of the predictor (pred_var) and the eob plane context (i.e., pl_ctx, which may indicate whether a chroma plane or intra coding mode is utilized). For example, a different threshold may be applied to the variance depending on the eob plane context, such as shown below:

```
static INLINE int get_pred_var_ctx(const int pred_var, const int
pl_ctx) {
  int pred_var_ctx = 0;
  if (pl_ctx != 1) { //chroma plane or intra mode
    pred_var_ctx = (pred_var < 10) ? 0 : 1;
  } else { // inter mode
    pred_var_ctx = (pred_var < 100) ?0 : 1;
  } return pred_var_ctx;
}
```

The CDF to be utilized for entropy coding may then be accessed from eob_flag_cdf[pl_ctx][pred_var_ctx] where eob_flag_cdf corresponds to the applicable CDF array based on transform block size.

The CDF can then be utilized for entropy coding. For example, an M-ary symbol arithmetic coding method can be used to entropy code syntax elements. In some implementations, integer M∈[2, 16]. An M-ary random variable requires a table of M−1 entries to represent its probability model. The probability mass function (PMF) may be represented as equation (1).

$${\overline{P}}_{n} = [ {p}_{1} ( n ) , {p}_{2} ( n ) , … , {p}_{M} ( n ) ] \qquad ( 1 )$$

The cumulative distribution function (CDF) may be represented as equation (2).

$${\overline{C}}_{n} = [ ( {c}_{1} ( n ) , {c}_{2} ( n ) , … , {c}_{M - 1} ( n ) , 1 ] , \qquad ( 2 )$$

In each of these equations, n refers to the time variable.

The probability model may utilize a per symbol update. When a symbol is coded, a new outcome k∈{1, 2, . . . , M} is observed. The probability model is then updated according to equation (3).

$${\overline{P}}_{n} = {\overline{P}}_{n - 1} ( 1 - α ) + α {\overline{e}}_{k} , \qquad ( 3 )$$

In equation (3), ēₖ is an indicator vector whose k-th element is 1 and the rest are 0, and a is the update rate. This translates into an equivalent CDF update equation (4).

$${c}_{m} ( n ) = \{ \begin{matrix}{c}_{m} ( n - 1 ) \cdot ( 1 - α ) , m < k \\ {c}_{m} ( n - 1 ) + α \cdot ( 1 - {c}_{m} ( n - 1 ) ) , m \geq k\end{matrix} \qquad ( 4 )$$

The update rate may be defined by equation (5), where count is the number of symbols coded at the time of the update.

$$α = \frac{1}{{2}^{3 + I ( c o u n t > 15 ) + I ( c o u n t > 31 ) + min ( {log}_{2} ( M ) , 2 )}} \qquad ( 5 )$$

FIG. 8 is a flow diagram of an example technique 800 for decoding an encoded video bitstream according to implementations of this disclosure. In some implementations, technique 800 may be performed using a computing device 100, a computing system 200, a decoder 500, or combinations thereof.

At step 810, prediction pixels are generated. Prediction pixels may be generated based on, for example, intra or inter coding techniques using previously decoded pixels of previously decoded frames or the current frame. Prediction pixels may be generated using other techniques or combinations of techniques. Prediction pixels may be generated in a prediction process separately from a transform decoding process. For example, prediction pixels may be generated using a prediction block by intra/inter prediction unit 540. The prediction block size used to generate prediction pixels may be different from the transform block size used to encode/decode a transform block and residual. When the block sizes are different, the prediction pixels corresponding to the transform block size of an encoded transform block may be utilized in connection with step 820.

At step 820, an indication of texture is determined for the prediction pixels corresponding to the transform block. The indication of texture can be calculated, for example, by calculating a SAD, SSD, or other calculation that indicates a variance of values and/or a rate of change of values in the prediction pixels, such as previously described. In some implementations, a comparison between the variance and a threshold may be used to determine the indication of texture. In some implementations a transform may be calculated, such as a DCT to determine the indication of texture.

At step 830, context for the end-of-block (EOB) position of the encoded transform block is determined based on the indication of texture. For example, the indication of texture can be compared to one or more threshold values to determine the context, such as previously described. For example, if the indication of texture is based on a transform, such as a DCT, the context can be based on values of one or more transform coefficients, distribution of or change in values of one or more transform coefficients, or combinations thereof. Other methodologies may be utilized, depending on how the indication of texture is determined. In some implementations, the threshold(s) can vary based on other context information, such as encoding mode or color plane.

At step 840, the EOB position is decoded based on the determined context. For example, the context can be used to select or look up an estimated probability model for the context, such as previously described. For example, in a case where the encoded transform block is entropy coded using an arithmetic coding implementation utilizing CDF's, the determined context can be used to select an array of CDF's to be used for entropy decoding, where the number of CDF's is based on the number of symbols used for encoding the EOB position. The selected probability model (e.g., the array of CDF's) is then used to entropy decode the EOB position. For example, in some implementations, the EOB position may be encoded using eob_pt and the CDF used to decode eob_pt may be obtained using a context based on a predictor variance such as previously described.

At step 850, the encoded transform block is decoded based on the decoded EOB position to produce a residual. For example, quantized transform coefficients may be entropy decoded (which may include a number of zero-valued coefficients inferred to be zero if they come after the EOB position), inverse quantized, and inverse transformed to arrive at a residual. For example, in some implementations, these steps may be performed by entropy decoding unit 510, dequantization unit 520, and inverse transform unit 530 as described with respect to decoder 500.

At step 860, the decoded block is reconstructed based on the prediction pixels and the residual. For example, the prediction pixels and the residual values can be added together to produce the decoded blocks, such as by reconstruction unit 550. Filtering can also be performed, such as by filter unit 560. The reconstruction process is further described above, including with respect to FIG. 7.

At step 870, the decoded block can be displayed on a display such as by displaying a frame of decoded video that includes the decoded block.

FIG. 9 is a flow diagram of an example technique 900 for encoding a video bitstream according to implementations of this disclosure. In some implementations, technique 900 may be performed using a computing device 100, a computing system 200, an encoder 400, or combinations thereof.

At step 910, prediction pixels are generated. Prediction pixels may be generated based on, for example, intra or inter coding techniques using previously decoded pixels of previously decoded frames or the current frame (for example, as produced in a reconstruction loop at 482 by encoder 400). Prediction pixels may be generated using other techniques or combinations of techniques. Prediction pixels may be generated in a prediction process separately from a transform decoding process. For example, prediction pixels may be generated using a prediction block by intra/inter prediction unit 410. The prediction block size used to generate prediction pixels may be different from the transform block size used to encode/decode a transform block and residual. When the block sizes are different, the prediction pixels corresponding to the transform block size of an encoded transform block may be utilized in connection with step 920.

At step 920, an indication of texture is determined for the prediction pixels corresponding to the transform block. The indication of texture can be calculated as described previously with respect to step 820. Compatible encoders and decoders will determine the indication of texture in a consistent manner so that both encoder and decoder will produce an indication of texture that results in the same context for a given encoded transform block.

At step 930, context for the EOB position of the encoded transform block is determined based on the indication of texture. The context can be determined as previously described with respect to step 830. Compatible encoders and decoders will determine the context in a consistent manner so that both encoder and decoder will determine the same context for a given encoded transform block.

At step 940, the EOB position is encoded based on the determined context. For example, the context can be used to select or look up an estimated probability model for the context, such as previously described. For example, in a case where the encoded transform block is entropy coded using an arithmetic coding implementation utilizing CDF's, the determined context can be used to select an array of CDF's to be used for entropy encoding, where the number of CDF's is based on the number of symbols used for encoding the EOB position. The selected probability model (e.g., the array of CDF's) is then used to entropy encode the EOB position. For example, in some implementations, the EOB position may be encoded using eob_pt and the CDF used to encode eob_pt may be obtained using a context based on a predictor variance such as previously described.

At step 950, the quantized transform block is encoded based on the encoded EOB position to produce an encoded transform block. For example, quantized transform coefficients may be entropy encoded (which may include a number of zero-valued coefficients inferred to be zero if they come after the EOB position), which may be performed by entropy encoding unit 440. The quantized transform coefficients may be obtained using a transform and quantization process. For example, in some implementations, the quantized transform coefficients in the quantized transform block may be obtained by transform unit 420 and quantization unit 430.

At step 960, a compressed bitstream is stored (e.g., compressed bitstream 404) that includes the encoded EOB position and the encoded transform block.

FIG. 10 is a flow diagram of an example technique 1000 for encoding or decoding an end-of-block position of a transform block according to implementations of this disclosure. In some implementations, technique 1000 may be performed using a computing device 100, a computing system 200, an encoder 400, or combinations thereof.

At step 1010, prediction pixels are generated. Prediction pixels may be generated using techniques described above with respect to step 810, step 910, or combinations thereof.

At step 1020, an indication of texture is determined for the prediction pixels corresponding to the transform block. The indication of texture can be calculated as described previously with respect to step 820, step 920, or combinations thereof.

At step 1030, context for the EOB position of a quantized transform block is determined based on the indication of texture. The context can be determined as previously described with respect to step 830, step 930, or combinations thereof.

At step 1040, the EOB position is entropy encoded or entropy decoded based on the determined context. For example, the EOB position may be entropy encoded or entropy decoded as described previously with respect to step 840, step 940, or combinations thereof.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product or compressed bitstream accessible from, for example, a tangible non-transitory computer-usable or non-transitory computer-readable medium. A computer-usable or computer-readable medium can be any device that can, for example, tangibly contain, store, communicate, or transport the program or compressed bitstream for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method for encoding or decoding an end-of-block position of a transform block, the method comprising:
determining a context for the end-of-block position based on an indication of texture of prediction pixels for a current block corresponding to a transform block; and
entropy encoding or entropy decoding the end-of-block position based on the context.

2. The method of claim 1, further comprising:
determining the indication of texture by calculating a variance of the prediction pixels.

3. The method of claim 2, wherein the context is determined based on a comparison between the variance and a threshold.

4. The method of claim 1, further comprising:
determining the indication of texture by calculating a discrete cosine transform of the prediction pixels.

5. The method of claim 4, wherein the context is determined based on a number of non-zero transform coefficients produced by calculating the discrete cosine transform of the prediction pixels.

6. The method of claim 1, wherein the transform block is an encoded transform block, the end-of-block position is utilized when decoding the encoded transform block, and the current block is decoded based on the transform block and the prediction pixels.

7. The method of claim 1, wherein the transform block is a quantized transform block, the quantized transform block is encoded based on the end-of-block position to produce an encoded transform block, a compressed bitstream including an encoding of the end-of-block position and the encoded transform block is stored, and the transform block is determined based on the current block and the prediction pixels.

8. A non-transitory computer-readable medium storing instructions, that when executed by a computer, cause the computer to encode or decode an end-of-block position of a transform block by:
determining a context for the end-of-block position based on an indication of texture of prediction pixels for a current block corresponding to a transform block; and
entropy encoding or entropy decoding the end-of-block position based on the context.

9. The non-transitory computer-readable medium of claim 8, further comprising instructions, that when executed by a computer, cause the computer to encode or decode an end-of-block position of a transform block by:
determining the indication of texture by calculating a variance of the prediction pixels.

10. The non-transitory computer-readable medium of claim 9, wherein the context is determined based on a comparison between the variance and a threshold.

11. The non-transitory computer-readable medium of claim 8, further comprising instructions, that when executed by a computer, cause the computer to encode or decode an end-of-block position of a transform block by:
determining the indication of texture by calculating a discrete cosine transform of the prediction pixels.

12. The non-transitory computer-readable medium of claim 11, wherein the context is determined based on a number of non-zero transform coefficients produced by calculating the discrete cosine transform of the prediction pixels.

13. The non-transitory computer-readable medium of claim 8, wherein the transform block is an encoded transform block, the end-of-block position is utilized when decoding the encoded transform block, and the current block is decoded based on the transform block and the prediction pixels.

14. The non-transitory computer-readable medium of claim 8, wherein the transform block is a quantized transform block, the end-of-block position is utilized when encoding the quantized transform block, and the transform block is determined based on the current block and the prediction pixels.

15. A non-transitory computer-readable medium storing a compressed bitstream including an encoded end-of-block position, wherein the encoded end-of-block position is encoded by an encoder or decodable by a decoder based on a context that is determined based on an indication of texture of prediction pixels for a current block corresponding to a transform block.

16. The non-transitory computer-readable medium of claim 15, wherein the compressed bitstream is encoded by the encoder or decodable by the decoder by determining the indication of texture by calculating a variance of the prediction pixels.

17. The non-transitory computer-readable medium of claim 16, wherein the context is determined based on a comparison between the variance and a threshold.

18. The non-transitory computer-readable medium of claim 15, wherein the compressed bitstream is encoded by the encoder or decodable by the decoder by determining the indication of texture by calculating a discrete cosine transform of the prediction pixels.

19. The non-transitory computer-readable medium of claim 18, wherein the context is determined based on a number of non-zero transform coefficients produced by calculating the discrete cosine transform of the prediction pixels.

20. The non-transitory computer-readable medium of claim 15, wherein the transform block is an encoded transform block, an end-of-block position decoded from the encoded end-of-block position is utilized when decoding the encoded transform block, and the current block is decoded based on the transform block and the prediction pixels.
